(19) United States
(12) Patent Application Publication
(10) Pub. No.: US 2016/0110286 A1
(43) Pub. Date: Apr. 21, 2016

(54) DATA WRITING METHOD AND MEMORY SYSTEM

(71) Applicant: HUAWEI TECHNOLOGIES CO.,LTD., Shenzhen (CN)

(72) Inventors: Fei XIA, Beijing (CN); Dejun JIANG, Beijing (CN); Jin XIONG, Beijing (CN)

(73) Assignee: HUAWEI TECHNOLOGIES CO.,LTD., Shenzhen (CN)

(21) Appl. No.: 14/982,353

(22) Filed: Dec. 29, 2015

Related U.S. Application Data
(63) Continuation of application No. PCT/CN2014/080073, filed on Jun. 17, 2014.

(30) Foreign Application Priority Data
Jun. 29, 2013 (CN) 201310270239.6

(51) Int. Cl. G06F 12/08; G06F 12/10

(52) U.S. Cl. CPC G06F 12/0811; G06F 12/109; G06F 2212/283; G06F 2212/657

(57) ABSTRACT

A data writing method and a memory system are disclosed. The method is applied to a memory system including at least a memory controller and a memory device, and the method includes: receiving, by the memory controller, change information sent by a cache, wherein the change information is information that is generated after the cache divides a first to-be-written cache line cache line of a last level cache LLC into at least one data block and that is used to indicate whether data in each of the at least one data block is changed; for each changed data block in which data is changed, sending, by the memory controller according to the change information, a corresponding column address and corresponding data to the memory device; and for a data block in which data is not changed, skipping performing, by the memory controller according to the change information, a write.

### CROSS-REFERENCE TO RELATED APPLICATIONS

This application is a continuation of International Application No. PCT/CN2014/080073, filed on Jun. 17, 2014, which claims priority to Chinese Patent Application No. 201310270239.6, filed on Jun. 29, 2013, both of which are hereby incorporated by reference in their entireties.

### TECHNICAL FIELD

Embodiments of the present disclosure relates to computer technologies, and in particular, to a data writing method and a memory system.

### BACKGROUND

An existing memory system basically includes a memory controller (MC), a memory device, and the like. The memory controller and the memory device exchange data by using the double data rate (DDR) protocol. The memory controller writes data into the memory device in a burst write manner, and a size of a data block on which one burst write is performed is a memory data bus width; a cache and the memory system exchange data in unit of cache line, and a size of data read or written each time is a size of one cache line of a last level cache (LLC) in the cache. Therefore, the memory controller needs to perform multiple consecutive burst writes to write data of one cache line into the memory device, where a quantity of consecutive burst writes is called a burst length (BL).

In the DDR3 protocol, a BL is generally equal to 8, and a size of a data block in one burst write is used as a granularity to divide one cache line into multiple data blocks. For example, if a size of one cache line of the LLC is 64 bytes and the memory data bus width is 64 bits, when burst write data appears on a data bus, the memory controller needs to perform eight burst writes in consecutive four clock cycles to write data of one cache line of the LLC into the memory device. However, actually, when data of one cache line of the LLC is written into the memory device, many data blocks are not changed. During a writing process, it is possible that invalid data (unchanged data) is written into the memory device in some burst writes. As a result, a speed of writing valid data (changed data) is low, and writing a large amount of invalid data leads to an increase in power consumption of the memory system, thereby reducing performance of the memory system.

In a BC4 (burst chop 4) technology supported by the DDR3 protocol, when the memory controller writes data into the memory device, a total of four burst writes occur in two consecutive clock cycles, and there is no burst write in subsequent two clock cycles, to write a first half or a latter half of data of one cache line into the memory device. During this process, within the first two clock cycles, it is also possible that in a write manner in which whether data in a data block is changed or not is not considered, invalid data is written into the memory device in some burst writes. As a result, a speed of writing valid data is low, and writing a large amount of invalid data leads to an increase in power consumption of the memory system, thereby reducing performance of the memory system.

### SUMMARY

Embodiments of the present disclosure provide a data writing method and a memory system, where whether data in a data block of a cache line is changed is differentiated and a write is performed only on a changed data block, so that objectives to quickly write valid data, reduce power consumption of a memory system, and improve performance of the memory system are achieved.

According to a first aspect, an embodiment of the present disclosure provides a data writing method, which is applied to a memory system including at least a memory controller and a memory device and includes:

receiving, by the memory controller, change information sent by a cache, where the change information is information that is generated after the cache divides a first to-be-written cache line of a last level cache (LLC) into at least one data block and that is used to indicate whether data in each of the at least one data block is changed; and

for each unchanged data block in which data is not changed as indicated by the change information, skipping sending, by the memory controller according to the change information, a column address corresponding to each unchanged data block and data corresponding to each unchanged data block to the memory device; and for each changed data block in which data is changed as indicated by the change information, sending, by the memory controller according to the change information, a column address corresponding to each changed data block and data corresponding to each changed data block to the memory device; and

writing, by the memory device according to the column address corresponding to each changed data block and the data corresponding to each changed data block, data of a burst length into each changed data block, where the burst length is equal to a quantity of the at least one data block.

In a first possible implementation manner of the first aspect, where the for each changed data block in which data is changed as indicated by the change information, sending, by the memory controller according to the change information, a column address corresponding to each changed data block and data corresponding to each changed data block to the memory device includes:

if a quantity of the changed data blocks of the first to-be-written cache line is equal to the burst length, sending, by the memory controller, the column address corresponding to each changed data block and the data corresponding to each changed data block to the memory device; and

the writing, by the memory device according to the column address corresponding to each changed data block and the data corresponding to each changed data block, data of a burst length into each changed data block includes:

performing, by the memory device according to the column address corresponding to each changed data block and the data corresponding to each changed data block, the data write of the burst length on each changed data block of the first to-be-written cache line.

In a second possible implementation manner of the first aspect, where the for each changed data block in which data is changed as indicated by the change information, sending, by the memory controller according to the change information, a column address corresponding to each changed data block and data corresponding to each changed data block to the memory device includes:

if a quantity of the changed data blocks of the first to-be-written cache line is less than the burst length, sending the column address and the data corresponding to each changed data block of the first to-be-written cache line and a column address and data corresponding to each changed data block of at least one second to-be-written cache line to the memory device, where a sum of a quantity of the changed data blocks of the at least one second to-be-written cache line and the quantity of the changed data blocks of the first to-be-written cache line is less than or equal to the burst length; and

the writing, by the memory device according to the column address corresponding to each changed data block and the data corresponding to each changed data block, data of a burst length into each changed data block includes:

performing, by the memory device according to each column address of the first to-be-written cache line and each column address of the at least one second to-be-written cache line, the data write of the burst length on each changed data block of the first to-be-written cache line and each changed data block of the at least one second to-be-written cache line, where the second to-be-written cache line is a to-be-written cache line except the first to-be-written cache line in the LLC.

With reference to the second possible implementation manner of the first aspect, in a third possible implementation manner of the first aspect, the first to-be-written cache line and the at least one second to-be-written cache line are in a same row of a same storage group Bank, and there is no read command of the same row in the LLC.

With reference to the first aspect or any one of the first to the third possible implementation manners of the first aspect, in a fourth possible implementation manner of the first aspect, the writing, by the memory device according to the column address corresponding to each changed data block and the data corresponding to each changed data block, data of a burst length into each changed data block includes:

when column address buffers whose quantity is equal to the burst length and column decoders whose quantity is equal to the burst length are disposed on the memory device, performing the data write on each changed data block by using an independent column address buffer and an independent column decoder.

According to a second aspect, an embodiment of the present disclosure provides a memory system, including at least a memory controller and a memory device, where:

the memory controller is configured to: receive change information sent by a cache, where the change information is information that is generated after the cache divides a first to-be-written cache line cache line of a last level cache (LLC) into at least one data block and that is used to indicate whether data in each of the at least one data block is changed; for each unchanged data block in which data is not changed as indicated by the change information, skip sending, according to the change information, a column address corresponding to each unchanged data block and data corresponding to each unchanged data block to the memory device; and for each changed data block in which data is changed as indicated by the change information, send, according to the change information, a column address corresponding to each changed data block and data corresponding to each changed data block to the memory device; and

the memory device is configured to write, according to the column address corresponding to each changed data block and the data corresponding to each changed data block, data of a burst length into each changed data block, where the burst length is equal to a quantity of the at least one data block.

In a first possible implementation manner of the second aspect, the memory controller is configured to: if a quantity of the changed data blocks of the first to-be-written cache line is equal to the burst length, send the column address corresponding to each changed data block and the data corresponding to each changed data block to the memory device; and

the memory device is configured to perform, according to the column address corresponding to each changed data block and the data corresponding to each changed data block, the data write of the burst length on each changed data block of the first to-be-written cache line.

In a second possible implementation manner of the second aspect, the memory controller is configured to: if a quantity of the changed data blocks of the first to-be-written cache line is less than the burst length, send the column address and the data corresponding to each changed data block of the first to-be-written cache line and a column address and data corresponding to each changed data block of at least one second to-be-written cache line to the memory device, where a sum of a quantity of the changed data blocks of the at least one second to-be-written cache line and the quantity of the changed data blocks of the first to-be-written cache line is less than or equal to the burst length; and

the memory device is configured to perform, according to each column address of the first to-be-written cache line and each column address of the at least one second to-be-written cache line, the data write of the burst length on each changed data block of the first to-be-written cache line and each changed data block of the at least one second to-be-written cache line, where the second to-be-written cache line is a to-be-written cache line except the first to-be-written cache line in the LLC.

With reference to the second possible implementation manner of the second aspect, in a third possible implementation manner of the second aspect, the first to-be-written cache line and the at least one second to-be-written cache line are in a same row of a same storage group Bank, and there is no read command of the same row in the LLC.

With reference to the second aspect or the first, the second, or the third possible implementation manner of the second aspect, in a fourth possible implementation manner of the second aspect, when column address buffers whose quantity is equal to the burst length and column decoders whose quantity is equal to the burst length are disposed on the memory device, the data write is performed on each changed data block by using an independent column address buffer and an independent column decoder.

In the data writing method and the memory system provided in the embodiments of the present disclosure, a memory controller sends, according to change information sent by a cache, a column address and data to a memory device only for a data block in which data is changed, so that the memory device performs a data write on each changed data block and does not perform a write on a data block in which data is not changed. Therefore, objectives to quickly write valid data, reduce power consumption of a memory system, and improve performance of the memory system are achieved.

### BRIEF DESCRIPTION OF DRAWINGS

To describe the technical solutions in the embodiments of the present disclosure more clearly, the following briefly introduces the accompanying drawings needed for describing the embodiments.

FIG. 1 is a flowchart of a data writing method according to embodiment 1 of the present disclosure;

FIG. 2 is a schematic diagram showing working of an LLC in the data writing method according to embodiment(s) of the present disclosure;

FIG. 3 is a schematic diagram showing working of a memory controller in the data writing method according to embodiment(s) of the present disclosure;

FIG. 4 is a schematic diagram showing working of a memory device in the data writing method according to embodiment(s) of the present disclosure;

FIG. 5 is a sequence diagram of write command combining in the data writing method according to embodiment(s) of the present disclosure; and

FIG. 6 is a schematic structural diagram of a memory system according to embodiment(s) of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure.

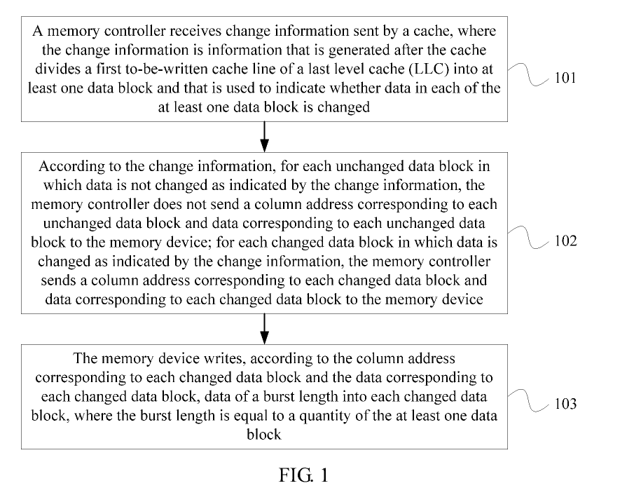

FIG. 1 is a flowchart of a data writing method according to Embodiment 1 of the present disclosure. This embodiment is applied to a scenario in which data is written into a memory system including at least a memory controller and a memory device. Specifically, this embodiment includes the following steps:

101. The memory controller receives change information sent by a cache, where the change information is information that is generated after the cache divides a first to-be-written cache line of a last level cache (LLC) into at least one data block and that is used to indicate whether data in each of the at least one data block is changed.

A cache is located between a central processing unit (CPU) and a large-capacity memory system and has a relatively high access rate. In this step, the cache divides the first to-be-written cache line of the last level cache (LLC) into at least one data block, and adds one flag bit to each of the at least one data block, where the flag bit indicates whether data in the data block is changed, one cache line needs multiple flag bits, and multiple flag bits of each cache line constitute change information indicating whether data in each of the at least one data block of the cache line is changed. For example, one cache line is divided into multiple data blocks by using a memory data bus width as a granularity, and one flag bit that is represented by 0 or 1 is added to each of the multiple data blocks, where 0 indicates that data in the data block is not changed, that is, a value of the data block is not changed; and 1 indicates that the data in the data block is changed, that is, the value of the data block is changed. Flag bits of each cache line constitute a changed block vector (CBV), that is, change information, of the cache line. Specifically, assuming that a size of one cache line is 64 bytes and the memory data bus width is 64 bits, one cache line may be divided into eight data blocks, and a burst length BL is equal to 8, that is, a size of one CBV is eight bits.

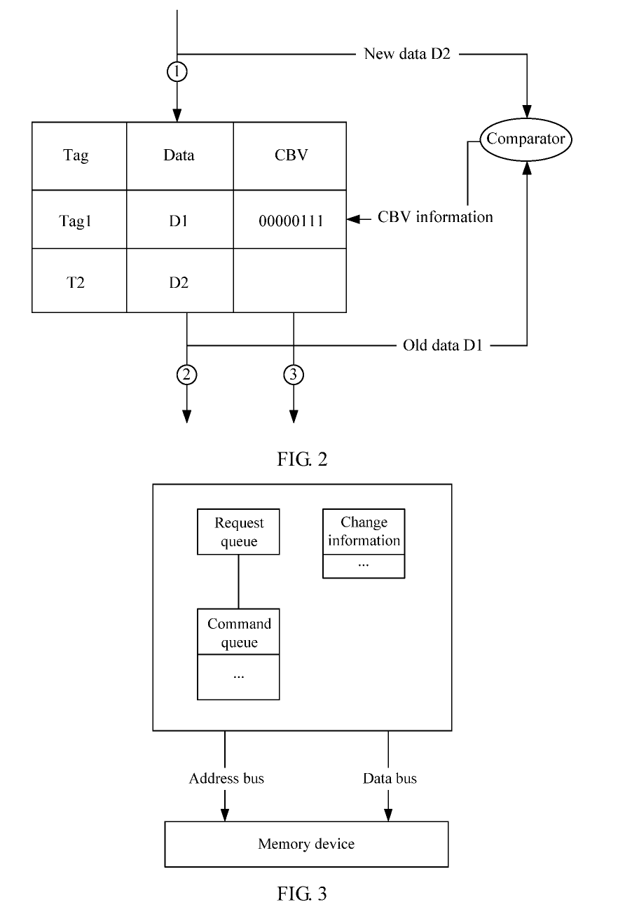

FIG. 2 is a schematic diagram showing working of an LLC in the data writing method according to embodiment(s) of the present disclosure. As shown in FIG. 2, when an upper-level cache of the cache writes data into one cache line of the LLC, the upper-level cache first reads old data in the cache line and compares the old data with to-be-written data (new data); if data in one data block is not changed, the upper-level cache sets a flag bit of this data block to 0; if the data is changed, the upper-level cache sets the flag bit of this data block to 1. When the LLC writes the data of the cache line to the memory system, CBV information corresponding to the cache line is transferred to the memory controller in the memory system, and the memory controller receives the CBV information, that is, receives corresponding change information. Taking a data block whose tag is Tag1 as an example, the upper-level cache executes the following steps: (1) when writing data into a cache line of the LLC, read old data D1 in the data block, first compares D1 with to-be-written data D2 by using a comparator, and record a comparison result in a CBV. Likewise, the upper-level cache reads data of other data blocks in the cache line, compares the data with new data that is to be written to these data blocks, and record a comparison result of each of the other data blocks in the CBV, to obtain CBV information of this cache line, that is, change information. When the LLC executes the following step: (2) write data into the memory system, that is, send a write request to the memory system to write data, the LLC simultaneously executes the following step: (3) send change information of the to-be-written cache line to the memory system.

102. According to the change information, for each unchanged data block in which data is not changed as indicated by the change information, the memory controller does not send a column address corresponding to each unchanged data block and data corresponding to each unchanged data block to the memory device; for each changed data block in which data is changed as indicated by the change information, the memory controller sends a column address corresponding to each changed data block and data corresponding to each changed data block to the memory device.

In this step, the memory controller in the memory system determines, according to the received change information, whether it is needed to perform a write on each data block of the first to-be-written cache line. Specifically, refer to FIG. 3.

FIG. 3 is a schematic diagram showing working of a memory controller in the data writing method according to embodiment(s) of the present disclosure. Referring to FIG. 3, the memory controller in the memory system includes a request queue (transaction queue), a command queue, and the like. The write request of the LLC is first placed in the request queue, the memory controller converts the write request to a specific command for operating the memory device and stores the command in the command queue. The memory controller determines, according to the change information of the first to-be-written cache line, whether it is needed to perform a write on each of the at least one data block of the first to-be-written cache line. Specifically, for an unchanged data block in which data is not changed, a burst write is not performed; for a changed data block in which data is changed, a column address and data corresponding to the changed data block is sent to the memory controller each beat by using an address bus, a data bus, and the like. Because data is transmitted in both a rising edge and a falling edge of one clock cycle in the DDR technology and a data frequency of the data bus is twice a clock frequency of the data bus, each beat is half a clock cycle.

103. The memory device writes, according to the column address corresponding to each changed data block and the data corresponding to each changed data block, data of a burst length into each changed data block, where the burst length is equal to a quantity of the at least one data block.

Generally, a quantity of data blocks into which the first to-be-written cache line is divided is a quantity of consecutive burst writes. In this step, the memory device performs the data write of the burst length on each changed data block according to each received column address and each piece of received data.

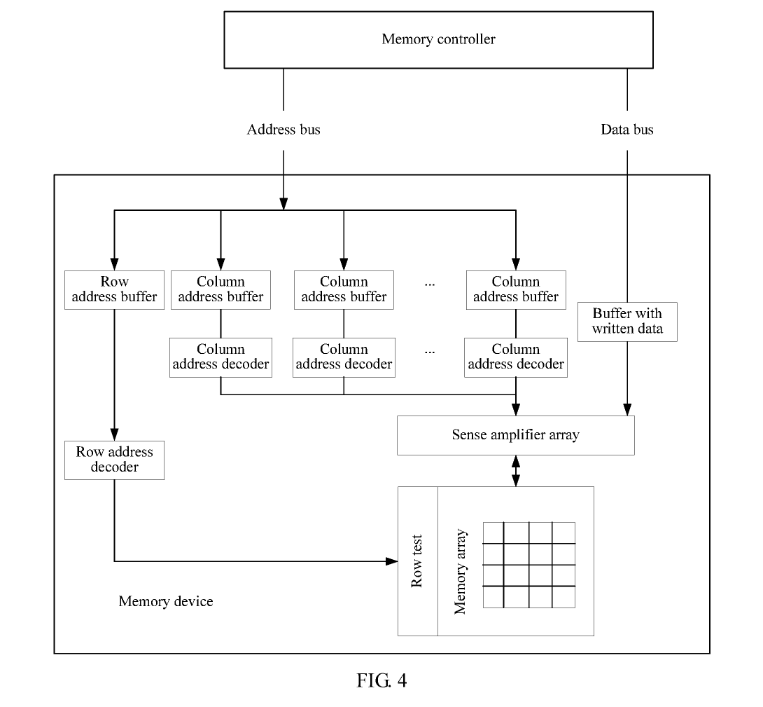

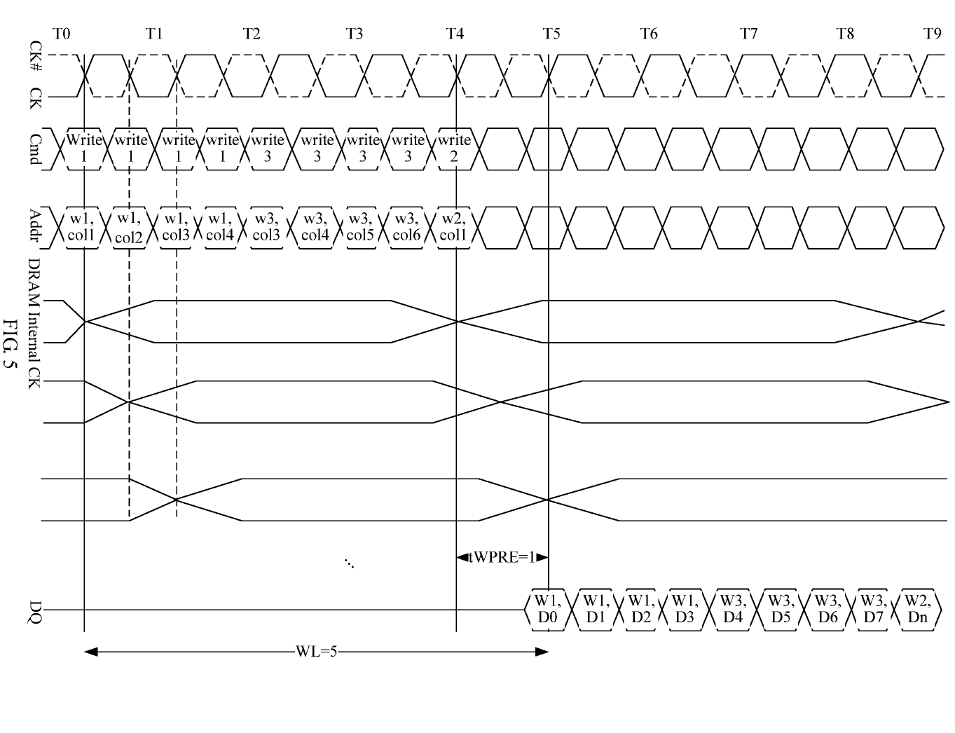

Optionally, compared with that one memory device has only one column address buffer and one column decoder in the prior art, the memory device in this embodiment includes multiple column address buffers and multiple column decoders. FIG. 4 is a schematic diagram showing working of a memory device in the data writing method according to embodiment(s) of the present disclosure. Referring to FIG. 4, in this embodiment, the memory device includes a row address buffer (row address buffer), a row address decoder (row decoder), column address buffers (column address buffer) whose quantity is equal to the burst length, column address decoders (column decoder) whose quantity is equal to the burst length, a sense amplifier array (sense amplifier array, SAA), a memory array (memory array), a buffer with written data (data in buffer) and the like. For each changed data block, the memory device performs a data write by using an independent column address buffer and an independent column decoder. Each time data is written, multiple column addresses sent by the memory controller are stored in different column address buffers and decoded concurrently by using different column decoders, different columns in the SAA are selected, data is written into these selected columns, and finally the data in the SAA is written into the memory array.

In the data writing method provided in this embodiment of the present disclosure, a memory controller sends, according to change information sent by a cache, a column address and data to a memory device only for a data block in which data is changed, so that the memory device performs a data write on each changed data block and does not perform a write on a data block in which data is not changed. Therefore, objectives to quickly write valid data, reduce power consumption of a memory system, and improve performance of the memory system are achieved.

Optionally, in the foregoing Embodiment 1, the memory controller determines, according to the change information, whether it is needed to perform a write on each of the at least one data block. For each changed data block in which data is changed as indicated by the change information, if a quantity of the changed data blocks of the first to-be-written cache line is equal to the burst length, the memory controller sends the column address corresponding to each changed data block and the data corresponding to each changed data block to the memory device. Correspondingly, the memory device performs, according to each column address, the data write of the burst length on each changed data block of the first to-be-written cache line.

Specifically, the cache divides the first to-be-written cache line of the LLC into at least one data block and performs one burst write on each of the at least one data block, where a quantity of data blocks obtained after the division is a quantity of burst writes, that is, the burst length. In this embodiment, if the quantity of the changed data blocks is equal to the burst length, that is, data in all the data blocks obtained after the division is changed, the change information received by the memory controller indicates that data in all the data blocks of the cache line is changed. In this case, for each of the at least one data block of the first to-be-written cache line, the memory controller sends a column address and data corresponding to the data block to the memory device; the memory device stores multiple received column addresses in different column address buffers, performs decoding concurrently by using different column decoders, selects different columns in the SAA, writes data to these selected columns, and finally writes the data in the SAA into the memory array. In this way, a write is performed on each of the at least one data block of the first to-be-written cache line. For example, the first to-be-written cache line is divided into eight data blocks by using the memory data bus width as a granularity, and data in all the eight data blocks is changed. Therefore, the memory controller sends eight column addresses and corresponding data to the memory device. Eight column address buffers and eight column decoders are disposed on the memory device, each column address buffer stores one column address, and the decoders corresponding to the column addresses perform decoding concurrently.

Optionally, in the foregoing Embodiment 1, the memory controller determines, according to the change information, whether it is needed to perform a write on each data block. For each changed data block in which data is changed as indicated by the change information, if a quantity of the changed data blocks of the first to-be-written cache line is less than the burst length, the memory controller sends the column address and the data corresponding to each changed data block of the first to-be-written cache line and a column address and data corresponding to each changed data block of at least one second to-be-written cache line to the memory device. A sum of a quantity of the changed data blocks of the at least one second to-be-written cache line and the quantity of the changed data blocks of the first to-be-written cache line is less than or equal to the burst length. Correspondingly, the memory device performs, according to each column address of the first to-be-written cache line and each column address of the at least one second to-be-written cache line, the data write of the burst length on each changed data block of the first to-be-written cache line and each changed data block of the at least one second to-be-written cache line, where the second to-be-written cache line is a to-be-written cache line except the first to-be-written cache line in the LLC.

Generally, the cache divides the first to-be-written cache line of the LLC into at least one data block and performs one burst write on each of the at least one data block, where a quantity of data blocks obtained after the division is a quantity of burst writes, that is, the burst length. In this embodiment, if the quantity of the changed data blocks is less than the burst length, data in only some data blocks of the data blocks obtained after the division is changed. In this case, when performing command scheduling, the memory controller combines write commands, and completes multiple write in a clock cycle of one fixed burst length by combining the write commands, thereby preventing waste of the clock cycle, reducing power consumption of the memory system, and improving performance of the memory system.

Specifically, write requests that are sent by the LLC to the memory controller and used to request that data of a size of the cache line is written are first stored in the request queue, and the memory controller converts these write requests to write commands for operating the memory device and stores the write commands in the command queue. When the memory device sends a write command of the first to-be-written cache line, if the memory controller discovers, according to the change information of the first to-be-written cache line, that the quantity of the changed data blocks of the cache line is less than the burst length, a write command corresponding to the at least one second to-be-written cache line is selected from the command queue. A sum of a quantity of changed data blocks of the at least one second to-be-written cache line and the quantity of the changed data blocks of the first to-be-written cache line is less than or equal to the burst length. In burst writes whose quantity is equal to the BL, the memory controller sends a column address and data corresponding to one changed data block of the first to-be-written cache line to the memory device each beat; after column addresses and data corresponding to the changed data blocks of the first to-be-written cache line are sent, the memory controller subsequently continues to send a column address and data corresponding to one changed data block of the second to-be-written cache line to the memory device each beat, and repeats this process until data is written into data blocks whose quantity is equal to the BL, or until write commands that can be combined cannot be found in the command queue, that is, a quantity of data blocks into which data is written is less than the BL.

It should be noted that, if the quantity of the changed data blocks of the first to-be-written cache line is less than the burst length, and the write command corresponding to the first to-be-written cache line and the write command corresponding to the at least one second to-be-written cache line need to be combined during the data writing process, the following needs to be met: the sum of the quantity of the changed data blocks of the at least one second to-be-written cache line and the quantity of the changed data blocks of the first to-be-written cache line is less than or equal to the burst length, where the first to-be-written cache line and the at least one second to-be-written cache line correspond to the write commands that can be combined. In addition, the write commands further needs to meet the following condition: the first to-be-written cache line and the at least one second to-be-written cache line are in a same row of a same storage group Bank, and there is no read command of the same row in the LLC. That is, the write command corresponding to the first to-be-written cache line and the write commands corresponding to the at least one second to-be-written cache line are used for a write in the same row of the same storage group Bank, and there is no read request of the same row in the write commands corresponding to the at least one second to-be-written cache line. In this case, referring to FIG. 4, the memory device further includes a row test module (row test), which is configured to test whether write commands are used to perform a data write in a same row of a same storage group Bank.

Specifically, it is assumed that a size of one cache line of the LLC is 64 bytes, the memory data bus width is 64 bits, and the burst length BL is equal to 8. Table 1 shows information about commands in the command queue of the memory controller: three write commands are used to operate a same Bank, write commands Write1 and Write3 are used for a write in a row Row1, and a write command Write2 is used for a write in row Row2.

TABLE 1

| Write | Row | CBV | | | | | | | |
|---|---|---|---|---|---|---|---|---|---|
| Write1 | Row1 | 1 | 1 | 1 | 1 | 0 | 0 | 0 | 0 |
| Write2 | Row2 | 1 | 1 | 1 | 0 | 0 | 0 | 0 | 0 |
| Write3 | Row1 | 0 | 0 | 1 | 1 | 1 | 1 | 0 | 0 |

As can be seen from Table 1, Write1 and Write3 are used for the write in the same row; CBV, namely change information, indicates that a sum of a quantity of changed data blocks of a cache line corresponding to Write1 and a quantity of changed data blocks of a cache line corresponding to Write3 (as shown in the cross-hatching in Table 1) is equal to 8. Therefore, write command combining is performed for Write1 and Write3; the memory controller schedules Write2 after completing scheduling Write1 and Write3. Specifically, refer to FIG. 5.

FIG. 5 is a sequence diagram of write command combining in the data writing method according to this embodiment of the present disclosure. As shown in FIG. 5, in the first four beats, that is, rising edges and falling edges of clock cycles T0 and T1, the memory controller sends Write1 and column address col1, col2, col3 and col4; in subsequent four beats, that is, rising edges and falling edges of clock cycles T2 and T3, the memory controller sends Write3 and column addresses col3, col4, col5 and col6. Then, the memory controller sends column addresses corresponding to Write2. At a moment T5, burst write data Dn appears on a data bus, and eight burst writes are performed, so that the changed data blocks of the cache line corresponding to Write1 and the cache line corresponding to Write3 are written into the memory device. Col1 indicates a column address corresponding to the first data block of eight data blocks of the cache line corresponding to Write1, and D1 indicates data corresponding to the first data block, and the rest can be deduced by analogy.

It should be noted that, in the foregoing embodiment, the embodiment of the present disclosure is described in detail by using an example in which two write commands Write1 and Write3 are combined and the sum of the quantity of the changed data blocks of the cache line corresponding to Write1 and the quantity of the changed data blocks of the cache line corresponding to Write3 is equal to BL. However, the embodiment of the present disclosure is not limited thereto. In another possible implementation manner, multiple write commands may be combined. For example, the sum of the quantity of the changed data blocks of the cache line corresponding to Write1 and the quantity of the changed data blocks of the cache line corresponding to Write3 is less than the BL, other write commands that can be combined may be selected from the command queue. In addition, if a sum of quantities of change data blocks of cache lines corresponding to all write commands that can be combined in the command queue is less than the BL, burst writes whose quantity is equal to the BL are performed, and some clock cycles in the burst writes whose quantity is equal to the BL or some beats of a clock cycle are idle. In addition, FIG. 5 shows only three memory clocks (internal CK) of a dynamic random access memory (dynamic random access memory, DRAM). In fact, there are a total of eight memory clocks.

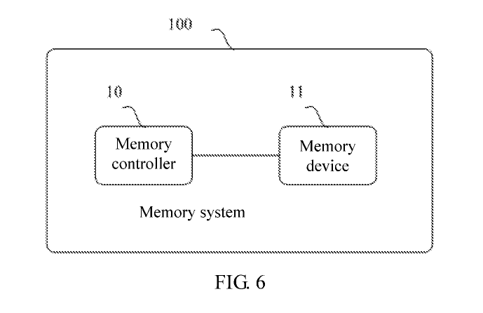

FIG. 6 is a schematic structural diagram of a memory system according to the embodiment of the present disclosure and is an apparatus embodiment corresponding to the embodiment of the present disclosure in FIG. 1; therefore, a specific implementation process is not described herein again. Specifically, a memory system 100 in this embodiment includes at least a memory controller 10 and a memory device 11.

Specifically, the memory controller 10 is configured to: receive change information sent by a cache, where the change information is information that is generated after the cache divides a first to-be-written cache line cache line of a last level cache (LLC) into at least one data block and that is used to indicate whether data in each of the at least one data block is changed; for each unchanged data block in which data is not changed as indicated by the change information, skip sending, according to the change information, a column address corresponding to each unchanged data block and data corresponding to each unchanged data block to the memory device; and for each changed data block in which data is changed as indicated by the change information, send, according to the change information, a column address corresponding to each changed data block and data corresponding to each changed data block to the memory device; and

the memory device 11 is configured to write, according to the column address corresponding to each changed data block and the data corresponding to each changed data block, data of a burst length into each changed data block, where the burst length is equal to a quantity of the at least one data block.

Further, the memory controller 10 is configured to: if a quantity of the changed data blocks of the first to-be-written cache line is equal to the burst length, send the column address corresponding to each changed data block and the data corresponding to each changed data block to the memory device 11.

The memory device 11 is configured to perform, according to each column address, the data write of the burst length on each changed data block of the first to-be-written cache line.

Further, the memory controller 10 is configured to: if a quantity of the changed data blocks of the first to-be-written cache line is less than the burst length, send the column address and the data corresponding to each changed data block of the first to-be-written cache line and a column address and data corresponding to each changed data block of at least one second to-be-written cache line to the memory device 11, where a sum of a quantity of the changed data blocks of the at least one second to-be-written cache line and the quantity of the changed data blocks of the first to-be-written cache line is less than or equal to the burst length; and

the memory device 11 is configured to perform, according to each column address of the first to-be-written cache line and each column address of the at least one second to-be-written cache line, the data write of the burst length on each changed data block of the first to-be-written cache line and each changed data block of the at least one second to-be-written cache line, where the second to-be-written cache line is a to-be-written cache line except the first to-be-written cache line in the LLC.

Further, the first to-be-written cache line and the at least one second to-be-written cache line are in a same row of a same storage group Bank, and there is no read command of the same row in the LLC.

Further, when column address buffers whose quantity is equal to the burst length and column decoders whose quantity is equal to the burst length are disposed on the memory device 11, where the number is equal to the burst length, the data write is performed on each changed data block by using an independent column address buffer and an independent column decoder.

Persons of ordinary skill in the art may understand that all or some of the steps of the method embodiments may be implemented by a program instructing relevant hardware. The program may be stored in a computer-readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A memory data updating method applied to a computer system comprising a CPU, a memory controller and a memory device, wherein the CPU comprises a last level cache (LLC), the method comprising:
dividing, by the CPU, a first cache line of the last level cache into k data blocks according to a burst write size, each of the k data blocks having a size equal to a multiple of the burst write size, wherein the burst write size is determined by a data bus width of the memory device, k is an integer and 2≦k≦burst length (BL), BL being a number of burst writes required for the memory controller to write data of one cache line of the last level cache into the memory device;
determining, by the CPU, update information of the first cache line, wherein the update information of the first cache line indicates an updating status for each of the k data blocks in the first cache line, and
sending, by the CPU, the update information of the first cache line to the memory controller.

2. The memory data updating method according to claim 1, wherein the step of determining update information of the first cache line comprises:
receiving, by the CPU, data in a buffer that is to be written into the first cache line;
creating a k-bits vector in a register, wherein each bit of the k-bits vector is to store the comparing result between the data that is to be written into a data block with data stored in the corresponding data block;
for each data block in the first cache line, comparing, by the CPU, the data in the buffer that is to be written into the each data block with data stored in the each data block; and
storing a comparison result for each data block into the bit corresponding to the data block in the k-bits vector in the register.

3. The memory data updating method according to claim 2, wherein the step of storing the comparison result comprises:
if the data that is to be written into the data block is the same as data stored in the data block, setting the bit corresponding to the data block in the k bits vector to 1;
if the data that is to be written into the data block and data stored in the data block are the same, setting the bit corresponding to the data block in the k bits vector to 0.

4. A memory data writing method applied to a computer system comprising a CPU, a memory controller and a memory device, wherein the CPU comprises a last level cache (LLC), the method comprising:
receiving, by the memory controller, update information of a first cache line in the last level cache and data of the first cache line sent by the CPU, wherein the update information of the first cache line indicates an updating status for each of k data blocks in the first cache line, wherein each of the k data blocks has a size equal to a multiple of a burst write size which is a size of a data block that equal to a memory data bus width, k is an integer and 2≦k≦burst length (BL), BL being a number of burst writes required by the memory controller to write data of one cache line into the memory device;
selecting, by the memory controller, changed data blocks in the first cache line according to the update information of the first cache line in the last level cache;
generating, by the memory controller, memory addresses of the changed data blocks of the first cache line in the last level cache, wherein each memory address comprises a row address and a column address of one changed data block; and
sending, by the memory controller, the memory addresses corresponding to the changed data blocks and data corresponding to the changed data blocks of the first cache line to the memory device for storing.

5. The method according to claim 4, wherein if a sum of the size of the changed data blocks of the first cache line is less than a length of the first cache line,
generating, by the memory controller, memory addresses of changed data blocks in a second cache line, wherein each memory address comprises a row address and a column address of each changed data block in the second cache line;
sending the memory addresses corresponding to the changed data blocks of the first cache line, data corresponding to the changed data blocks of the first cache line, the memory addresses corresponding to the changed data blocks of the second cache line and data corresponding to the changed data blocks of the second cache line to the memory device, wherein a sum of a size of the changed data blocks of the second cache line and the sum of the size of the changed data blocks of the first cache line is less than or equal to the length of the first cache line in the last level cache.

6. The method according to claim 5, wherein the row address of each changed data block in the second cache line and the row address of each changed data block in the first cache line are the same, and there is no read command for the same row address in the memory device.

7. A computer system, which comprises a CPU and a memory system, wherein the CPU comprises a last level cache (LLC), and the memory system comprises a memory controller and a memory device, wherein:
the cache is configured to: divide a first cache line of the last level cache into k data blocks according to a burst write size, each of the k data blocks having a size equal to a multiple of the burst write size, wherein the burst write size is determined by a data bus width of the memory device, k is an integer, and 2≦k≦burst length (BL), BL being a number of burst writes required for the memory controller to write data of one cache line of the last level cache into the memory device; determine update information of the first cache line, wherein the update information of the first cache line indicates an updating status for each of the k data blocks in the first cache line, and send the update information of the first cache line to the memory controller;
the memory controller is configured to: receive update information of the first cache line in the last level cache and data of the first cache line sent by the CPU, wherein the update information of the first cache line indicates an updating status for each of k data blocks in the first cache line, wherein each of the k data blocks has a size that equal to a multiple of a burst write size which is a size of a data block that equal to a memory data bus width, k is an integer, and 2≦k≦burst length (BL), BL being a number of burst writes required by the memory controller to write data of one cache line into the memory device; select changed data blocks in the first cache line according to the update information of the first cache line; generate memory addresses of the changed data blocks of the first cache line in the last level cache, wherein each memory address comprises a row address and a column address of one changed data block; and send the memory addresses corresponding to the changed data blocks and data corresponding to the changed data blocks of the first cache line to the memory device for storing; and
the memory is configured to: receive the memory addresses corresponding to the changed data blocks and data corresponding to the changed data blocks of the first cache line, and perform writing, according to the memory addresses corresponding to the changed data blocks and the data corresponding to the changed data blocks, the data of the changed data blocks in the memory device.

8. The computer system according to claim 7, wherein the memory controller is configured to: if a sum of the size of the changed data blocks of the first cache line is less than a length of the first cache line,
generate memory addresses of changed data blocks in a second cache line, wherein each memory address comprises a row address and a column address of each changed data block in the second cache line;
send the memory addresses corresponding to the changed data blocks of the first cache line, data corresponding to the changed data blocks of the first cache line, the memory addresses corresponding to the changed data blocks of the second cache line and data corresponding to the changed data blocks of the second cache line to the memory device, wherein a sum of a size of the changed data blocks of the second cache line and the sum of the size of the changed data blocks of the first cache line is less than or equal to the length of the first cache line in the last level cache.

9. The computer system according to claim 8, wherein the row address of the changed data blocks in the second cache line and the row address of each changed data block in the first cache line are the same, and there is no read command for the same row address in the memory device.

10. The computer system according to claim 7, wherein column address buffers whose quantity is equal to the burst length and column address decoders whose quantity is equal to the burst length are configured on the memory device, and each column address of each changed data block is processed by using an independent column address buffer and an independent column decoder.

11. The computer system according to claim 8, wherein column address buffers whose quantity is equal to the burst length and column address decoders whose quantity is equal to the burst length are configured on the memory device, and each column address of each changed data block is processed by using an independent column address buffer and an independent column decoder.

12. The computer system according to claim 9, wherein when column address buffers whose quantity is equal to the burst length and column address decoders whose quantity is equal to the burst length are configured on the memory device, and each column address of each changed data block is processed by using an independent column address buffer and an independent column decoder.
